(19) United States
(12) Patent Application Publication
(10) Pub. No.: US 2011/0127124 A1
(43) Pub. Date: Jun. 2, 2011

(54) Coulomb Friction Damped Disc Brake Caliper Bracket

(75) Inventors: Brent D. Lowe, Milford, MI (US); Mark T. Riefe, Brighton, MI (US); Omar S. Dessouki, Beverly Hills, MI (US); Mohan Sundar, Troy, MI (US); Chia N. Yang, Wixom, MI (US)

(73) Assignee: GM GLOBAL TECHNOLOGY OPERATIONS, INC., DETROIT, MI (US)

(21) Appl. No.: 12/628,466

(22) Filed: Dec. 1, 2009

(51) Int. Cl. F16D 65/14

(52) U.S. Cl. 188/73.37

(57) ABSTRACT

A Coulomb friction damped disc brake caliper bracket, wherein damping is provided by Coulomb friction, most preferably at the outboard tie-bar thereof, by a Coulomb bar peripherally welded thereto. An inner surface of the Coulomb friction bar is in abutting contact with the external surface of the tie-bar, whereby because of the continuous peripheral edge welding, corrosion cannot find entry into the interface of the two surfaces, yet the two surfaces form are free to vibrate one as to the other in Coulomb friction fashion to thereby provide damping and reduction of brake squeal and other noise.

### TECHNICAL FIELD

The present invention relates to disc brake caliper brackets used in automotive applications, and more particularly to Coulomb friction damped disc brake caliper brackets.

### BACKGROUND OF THE INVENTION

Motor vehicle disc brake systems utilize a disc brake unit, composed of a disc brake rotor and a disc brake caliper, at each respective wheel.

The disc brake rotor typically includes a rotor hat for connecting to an axle hub of a rotatable axle of the motor vehicle, and at least one annular rotor cheek connected to the rotor hat, wherein the at least one rotor cheek has a pair of mutually opposed braking surfaces onto which brake pads are selectively applied when braking is desired. Typically, the rotor cheek configuration may be solid, in which case a single rotor cheek has opposing braking surfaces thereon, or may be vented, in which case a pair of rotor cheeks are mutually separated by a web of ventilation vanes and each rotor cheek provides a respective braking surface so that, in combination, two mutually opposed braking surfaces are provided.

A disc brake caliper includes, as shown at FIG. 1, a generally U-shaped caliper bracket 10, including outboard tie-bar 12 and an inboard tie-bar 14. The caliper bracket supports a mutually opposed pair of brake pads, one brake pad disposed overlying a respective rotor cheek braking surface, wherein the caliper, the brake pads, and other associated brake components collectively form a “brake corner”. Normally, the caliper keeps the brake pads separated from the braking surfaces of the one or more rotor cheeks, and braking of the motor vehicle occurs at the brake corner by hydraulically actuating the brake pads to press upon the braking surfaces of the one or more rotor cheeks. Frictional interaction between the one or more rotating rotor cheeks and non-rotating brake pads causes braking of the motor vehicle to transpire, the rate of braking depending upon the pressure of the brake pads against the braking surfaces.

Brake squeal can be undesirably generated at the brake corner when braking occurs, particularly in the frequency range from 2 kHz to 6 kHz. This brake squeal is the result of modal excitations of the disc brake rotor (composed usually of cast iron) and/or the disc brake caliper bracket by the frictional interaction of the brake pads.

With regard to the disc brake rotor, it is known in the prior art that brake squeal can be addressed by reducing modal excitation on the disc brake rotor by the selection of friction material of the brake pads (ie., lowering the frictional coefficient), by modifying the modal excitation response of the brake corner via changing the modal properties of the rotor cheeks (ie., in terms of resonant frequencies, mode shapes, and structural damping through higher carbon content of the one or more rotor cheeks and/or increasing the disc brake rotor mass, or using exotic, expensive materials), and by introducing additional damping for example via a shim disposed at a backing plate of the brake pads.

With regard to the disc brake caliper, countermeasures to reduce low-frequency brake squeal include: 1) increasing the stiffness of the caliper bracket by increasing the cross-sectional area of the tie-bars, or 2) casting in or mechanically attaching a mass to the caliper bracket, wherein the mass acts as a vibration damper and/or changes the dynamic response of the caliper bracket.

The aforementioned brake squeal countermeasures are relatively effective for most brake corner designs, but they require a significant amount of testing and analytical resources in order to be effective. And unfortunately, brake corners for performance motor vehicles, or those motor vehicles with high friction lining materials, are resistant to the prior art brake squeal countermeasures, due to the high amount of modal excitation from the friction material of the brake pads.

A breakthrough in disc brake technology, which is aimed at eliminating brake squeal originating at the disc brake rotor, is described in U.S. Patent Application Publication US2006/0076200A1, published Apr. 13, 2006 to Dessouki, et al. In this disclosure, a Coulomb friction damped disc brake rotor is described, wherein damping of the modal excitations is provided generally coextensively with the braking surfaces of the one or more rotor cheeks. In this disclosure, the Coulomb friction damped disc brake rotor has at least one interfacial boundary formed in at least one rotor cheek which is disposed in generally coextensive relation to the braking surface thereof. In this regard, by “interfacial boundary” is meant a mechanically distinguishable surface boundary between two surfaces which are in mutual contact such that a state of Coulomb friction exists therebetween, and wherein the term “Coulomb friction” represents the energy absorption processes at the interface between two material surfaces through mechanical interaction of the surfaces, as for example temperature, pressure, time, etc. In a preferred embodiment of the Coulomb friction damped disc brake rotor according to the disclosure, an insert is disposed in at least one rotor cheek of a disc brake rotor having either a solid or vented rotor cheek configuration, wherein the insert provides mutually opposed interfacial boundaries with respect to the surrounding rotor cheek, and wherein the insert is annularly configured and disposed generally coextensively with a braking surface of the rotor cheek. Alternatively, a plurality of inserts may be provided in the one or more rotor cheeks. Alternatively further, the interfacial boundary may be provided by an interstice formed in the rotor cheek in which the surfaces of rotor cheek which define the interstice mutually form therebetween the interfacial boundary, wherein any number of interstices may be provided in one or more rotor cheeks.

In U.S. Patent Application Publication US2007/0023240A1, published on Feb. 1, 2007, to Dessouki, et al, a Coulomb friction damped disc brake caliper bracket is described, wherein damping of the modal excitations is provided, and wherein the term “Coulomb friction” represents energy absorption processes at an interface between two material surfaces through mechanical interaction of the surfaces, as for example temperature, pressure, time, etc. According to a first embodiment thereof, one or more clamping members is exteriorly clamped onto the disc brake caliper bracket so as to provide a compressive force thereto; and according to a second embodiment thereof, at least one interfacial boundary internally formed in the disc brake caliper bracket, preferably, at one or both of the inboard and outboard tie-bars, and most preferably disposed at the outboard tie-bar, wherein by “interfacial boundary” is meant a mechanically distinguishable surface boundary between two surfaces which are in mutual contact such that a state of Coulomb friction exists therebetween.

While the aforementioned U.S. Patent Application Publication US2007/0023240A1 solves the problem of brake squeal by use of Coulomb friction, a problem that needs to be overcome is that of corrosion at the interface of the two surfaces.

Accordingly, what remains needed in the art is to somehow provide Coulomb friction damping of the disc brake caliper bracket, so as to eliminate brake squeal at the disc brake corner, yet avoid any problems with corrosion at the interface of the two surfaces.

### SUMMARY OF THE INVENTION

The present invention is a Coulomb friction damped disc brake caliper bracket, wherein damping of the modal excitations is provided, and wherein the term “Coulomb friction” represents energy absorption processes at an interface between two material surfaces through mechanical interaction of the surfaces, as for example temperature, pressure, time, etc.

The Coulomb friction damped disc brake caliper bracket according to the present invention has at least one Coulomb friction bar welded to the external surface of the disc brake caliper bracket, preferably disposed at one or both of the inboard and outboard tie-bars, and most preferably disposed at the outboard tie-bar. The Coulomb friction bar has an inner surface in abutting contact with the external surface of the tie-bar, whereby because of peripheral welding in the form of continuous welding along the peripheral edge of the Coulomb friction bar, corrosion cannot find entry into the interfacial boundary between the two surfaces, yet the two surfaces are free to vibrate one as to the other in Coulomb friction fashion to thereby provide damping and reduction of brake squeal and other noise.

The Coulomb friction damped disc brake caliper bracket according to the present invention provides an interfacial boundary between the Coulomb friction bar inner surface and the tie-bar external surface, wherein by “interfacial boundary” is meant a mechanically distinguishable surface boundary between two surfaces which are in mutual contact such that a state of Coulomb friction exists therebetween. In this regard, it is further believed that the interfacial boundary has the following attributes: 1) the greater the surface area of the interfacial boundary, the greater will be the damping; 2) the greater the number of interfacial boundaries, the greater will be the damping; 3) pre-tensioning and/or pre-loading is not required so long as the interfacial boundary provides Coulomb friction damping; and 4) the peripheral welding will not impair the Coulomb friction process at the interfacial boundary.

Accordingly, it is an object of the present invention to provide a Coulomb friction damped disc brake caliper bracket, wherein a Coulomb friction bar is peripherally welded to an external surface of a tie-bar.

This and additional objects, features and advantages of the present invention will become clearer from the following specification of a preferred embodiment.

### BRIEF DESCRIPTION OF THE DRAWINGS

FIG. 1 is a perspective view of prior art disc brake caliper bracket.

FIG. 2 is a perspective view of the Coulomb friction damped disc brake caliper bracket according to the present invention, wherein a Coulomb friction bar is peripherally welded onto the outboard tie-bar.

FIG. 3 is a sectional view, seen along line 3-3 of FIG. 2.

FIG. 4 is a side view of a side view of the external surface of a cut-away portion of a caliper tie-bar, showing a Coulomb friction bar and its peripheral welding to the tie-bar.

FIG. 5 is a sectional view, similar to FIG. 3, wherein now a pair of Coulomb friction bars is depicted.

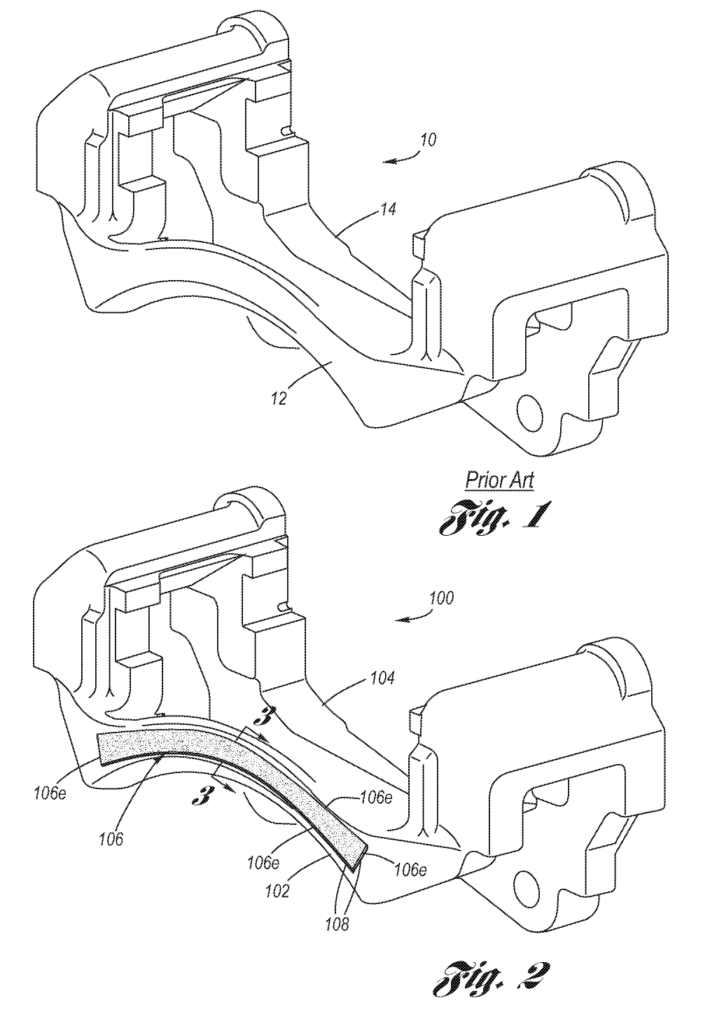

### DESCRIPTION OF THE PREFERRED EMBODIMENT

Referring now to the Drawing, FIGS. 2 through 5 depict various aspects of an example of a Coulomb friction damped disc brake caliper bracket 100 for motor vehicle disc brake applications.

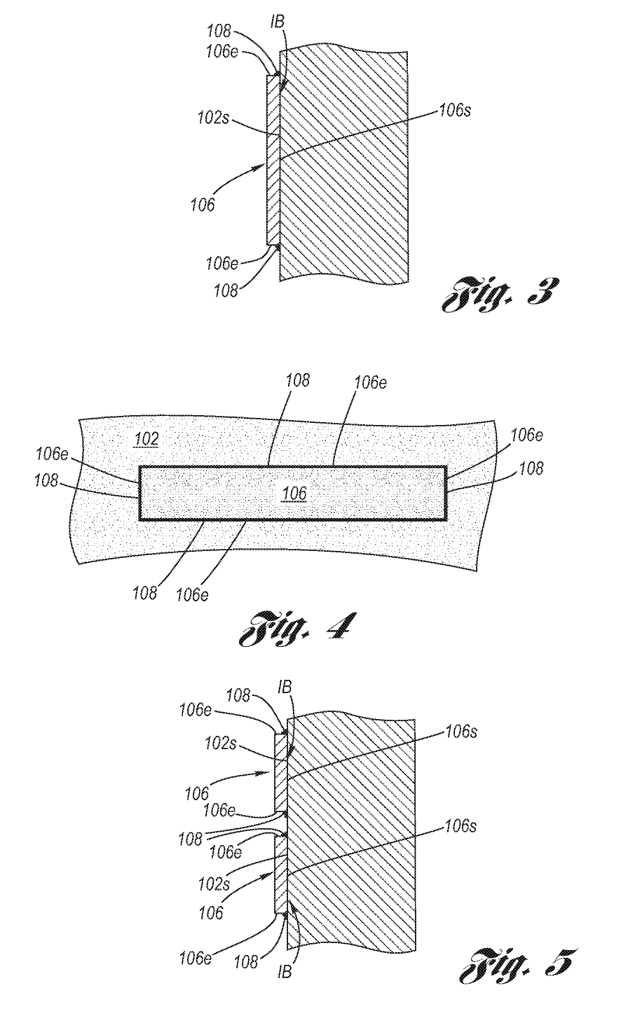

In a disc brake caliper of a disc brake corner, FIGS. 2 and 3 depict a non-limiting example of a Coulomb friction damped disc brake caliper bracket 100, which may be shaped differently from that shown at FIG. 2, which includes an outboard tie-bar 102 and an inboard tie-bar 104.

Per the example shown in FIG. 2, a Coulomb friction bar 106 is peripherally welded 108 to the external surface 102s of the outboard tie-bar 102. By the term “peripherally welded” is meant that the peripheral edge 106e of the Coulomb friction bar 106 is continuously welded therealong as a closed circuit or path to the external surface 102s of the outboard tie-bar 102 (see FIG. 4), wherein the metal fusing adduced by the peripheral welding provides an environmental seal which precludes the elements (moisture, rain, snow, etc.) from passing through the peripheral weld 108.

FIG. 3 shows that although the peripheral edge 106e of the Coulomb friction bar 106 has been peripherally welded to the outboard tie-bar 102, the inner surface 106s of the Coulomb friction bar 106 touchingly abuts the external surface 102s of the external tie-bar such that the two surfaces are free to vibrate one as to the other with a state of Coulomb friction existing therebetween.

The Coulomb friction damped disc brake caliper bracket 100 provides an interfacial boundary IB between the Coulomb friction bar inner surface 106s and the tie-bar external surface 102s, wherein by “interfacial boundary” is meant a mechanically distinguishable surface boundary between two surfaces which are in mutual contact such that a state of Coulomb friction exists therebetween.

By way of example, the Coulomb friction bar may be composed of steel, and to minimize cost, could be composed of a low-grade steel. Further, while the Coulomb friction bar 106 is preferred to be peripherally welded to the outboard tie-bar because this component of the caliper bracket exhibits the largest amount of deflection during brake squeal events, the Coulomb friction bar could be welded to another location of the disc brake caliper bracket, as for example the inboard tie-bar, anchor, and/or the abutment areas thereof. Further, as shown at FIG. 5, there may be any number of Coulomb friction bars 106 disposed at, and peripherally welded to, any location of the disc brake caliper bracket 100.

### Example I

A pair of production disc brake rear wheel corner caliper brackets were used, one of them being modified into a prototype disc brake rear wheel corner caliper bracket having a Coulomb friction bar peripherally welded to the outboard tie-bar. Damping measurements were taken on the remaining production disc brake caliper bracket and the prototype disc brake caliper bracket, and the following damping levels were measured:

| Caliper Bracket | 1^{st} Tie-Bar Mode | 2^{nd} Tie-Bar Mode |
|---|---|---|
| Production | 0.20 | 0.09 |
| Prototype | 0.35 | 0.12 |

It is seen that for the first tie-bar modal excitations, a 75% increase was shown for the prototype disc brake caliper bracket as compared to the production disc brake caliper bracket; and that for the second tie-bar modal excitations, a 33% increase was shown for the prototype disc brake caliper bracket as compared to the production disc brake caliper bracket. These increases reflect the Coulomb friction damping provided by the presence of the peripherally welded Coulomb friction bar.

Accordingly, it is believed that the interfacial boundary IB has the following attributes: 1) the greater the surface area of the interfacial boundary, the greater will be the damping; 2) the greater the number of interfacial boundaries, the greater will be the damping; 3) pre-tensioning and/or pre-loading is not required so long as the interfacial boundary provides Coulomb friction damping; and 4) the peripheral welding will not impair the Coulomb friction process at the interfacial boundary. In this regard, therefore, the peripheral welding 108 along the peripheral edge 106e of the Coulomb friction bar 106 prevents environmental corrosion at the interfacial boundary IB, yet the two surfaces 106s, 102s are free to vibrate one as to the other in Coulomb friction fashion to thereby provide damping and reduction of brake squeal and other noise.

To those skilled in the art to which this invention appertains, the above described preferred embodiment may be subject to change or modification. Such change or modification can be carried out without departing from the scope of the invention, which is intended to be limited only by the scope of the appended claims.

1. A Coulomb friction damped disc brake caliper bracket, comprising:
a disc brake caliper bracket having an external surface; and
at least one Coulomb friction bar peripherally welded to the external surface of said caliper bracket, wherein an inner surface of said at least one Coulomb friction bar is in touching abutment with respect to the external surface of said caliper bracket so as to form an interfacial boundary therebetween such that a state of Coulomb friction exists between the external surface of said caliper bracket and the inner surface of said least one Coulomb friction bar.

2. The Coulomb friction damped disc brake caliper bracket of claim 1, wherein said caliper bracket comprises an outboard tie-bar; wherein said at least one Coulomb friction bar is peripherally welded to the external surface at said outboard tie-bar.

3. The Coulomb friction damped disc brake caliper bracket of claim 1, wherein said at least one Coulomb friction bar has a peripheral edge;
wherein said peripheral welding comprises welding of said at least one Coulomb friction bar to said tie-bar continuously along a closed path around the peripheral edge; and wherein said peripheral welding provides an environmental seal with respect to said touching abutment of the inner and external surfaces.

4. The Coulomb friction damped disc brake caliper bracket of claim 3, wherein said caliper bracket comprises an outboard tie-bar; wherein said at least one Coulomb friction bar is peripherally welded to the external surface at said outboard tie-bar.

5. The Coulomb friction damped disc brake caliper bracket of claim 3, wherein said at least one Coulomb friction bar comprises a plurality of Coulomb friction bars.

6. The Coulomb friction damped disc brake caliper bracket of claim 5, wherein said caliper bracket comprises an outboard tie-bar; wherein at least one Coulomb friction bar of said plurality of Coulomb friction bars is peripherally welded to the external surface at said outboard tie-bar.

7. The Coulomb friction damped disc brake caliper bracket of claim 1, wherein said at least one Coulomb friction bar comprises a plurality of Coulomb friction bars.

8. A Coulomb friction damped disc brake caliper bracket, comprising:
a disc brake caliper bracket having an external surface; and
at least one Coulomb friction bar having a peripheral edge, said at least one Coulomb friction bar being peripherally welded to the external surface of said caliper bracket, wherein an inner surface of said at least one Coulomb friction bar is in touching abutment with respect to the external surface of said caliper bracket so as to form an interfacial boundary therebetween such that a state of Coulomb friction exists between the external surface of said caliper bracket and the inner surface of said least one Coulomb friction bar;
wherein said peripheral welding comprises welding of said at least one Coulomb friction bar to said tie-bar continuously along a closed path around the peripheral edge; and wherein said peripheral welding provides an environmental seal with respect to said touching abutment of the inner and external surfaces.

9. The Coulomb friction damped disc brake caliper bracket of claim 8, wherein said caliper bracket comprises an outboard tie-bar; wherein said at least one Coulomb friction bar is peripherally welded to the external surface at said outboard tie-bar.

10. The Coulomb friction damped disc brake caliper bracket of claim 8, wherein said at least one Coulomb friction bar comprises a plurality of Coulomb friction bars.

11. The Coulomb friction damped disc brake caliper bracket of claim 10, wherein said caliper bracket comprises an outboard tie-bar; wherein at least one Coulomb friction bar of said plurality of Coulomb friction bars is peripherally welded to the external surface at said outboard tie-bar.
